(19) United States
(12) Patent Application Publication
(10) Pub. No.: US 2013/0106550 A1
(43) Pub. Date: May 2, 2013

(54) COIL COMPONENT AND MANUFACTURING METHOD THEREOF

(71) Applicant: TMP International Corporation, New Taipei City (TW)

(72) Inventor: Ming-Chi CHEN, New Taipei City (TW)

(73) Assignee: TMP INTERNATIONAL CORPORATION, New Taipei City (TW)

(21) Appl. No.: 13/666,737

(22) Filed: Nov. 1, 2012

(30) Foreign Application Priority Data
Nov. 1, 2011 (TW) 100139687
Nov. 1, 2011 (TW) 100220509

(51) Int. Cl. H01F 27/29; H01F 41/00; H01F 27/28

(52) U.S. Cl. 336/170; 336/220; 336/192; 29/605

(57) ABSTRACT

A manufacturing method of a coil component comprises a forming step to form a first coil and a second coil connecting to each other, wherein the first coil is disposed at the inside of the second coil; a disposing step to dispose a part of a tail segment of the first coil on a last-loop segment of the second coil along a contour of the last-loop segment of the second coil; and a covering step to cover the first coil and the second coil.

### CROSS REFERENCE TO RELATED APPLICATIONS

This Non-provisional application claims priority under 35 U.S.C. §119(a) on Patent Application No(s). 100139687 and 100220509 filed in Taiwan, Republic of China on Nov. 1, 2011 and Nov. 1, 2011, the entire contents of which are hereby incorporated by reference.

### BACKGROUND OF THE INVENTION

1. Field of Invention

The invention relates to a coil and a manufacturing method thereof and, in particular, to a coil component and a manufacturing method thereof.

2. Related Art

The coil component is a fundamental electronic device that has been widely used. It can be used as an electromagnetic winding coil of an inductor or a motor.

FIG. 1A is a top view of a conventional coil component 1, and FIG. 1B is a perspective view of the coil component 1. As shown in FIGS. 1A and 1B, the coil component 1 includes two coils 11 and 12, two electrode pins 13 and 14, and a covering body 15. The coil 11 is disposed at the inside of the coil 12, and connected with the coil 12. The tail portions of the coils 11 and 12 are used as the conducting contacts to connect the electrode pins 13 and 14. The covering body 15 covers the coils 11 and 12.

The coils 11 and 12 are wound as a three-dimensional spiral, in which the coil 11 is first wound as an inner spiral, and then the coil 12 is wound as an outer spiral. Hence, the tail portion of the coil 12 as the outer spiral is disposed at the outer side of the coil component 1, and the tail portion of the coil 11 as the inner spiral is disposed at the inner side of the coil component 1. In order to make the tail portion of the inner spiral coil 11 electrically connect to the outside electrode pin 13, the tail portion of the inner spiral coil 11 needs to be radially extended across the outer coil, as shown the dotted area in FIG. 1B. However, after a period of usage, the superimposed portion of the coil 11 and the coil 12 will be easily damaged due to the rubbing, so that the insulating layer of the coil will be easily cracked. Therefore, the coil component 1 will not operate normally, resulting in the shortened life cycle and poor durability.

Otherwise, if the tail portion of the inner coil is not extended across the outer coil, an additional conducting wire needs to be disposed to connect the tail portion of the inner coil. In this case, the conducting wire needs to be manufactured and soldered, increasing the manufacturing steps and the production cost of the coil component 1. Besides, soldering the coil will cause a soldering point, which leads to higher fraction defective so that the quality becomes uncontrollable.

Therefore, it is an important subject to provide a coil component that has simple structure, better durability and longer life cycle.

### SUMMARY OF THE INVENTION

In view of the foregoing subject, an objective of the present invention is to provide a coil component that has simple structure, better durability and longer life cycle, and a manufacturing method thereof.

To achieve the above objective, the present invention discloses a manufacturing method of a coil component, which comprises: a forming step to form a first coil and a second coil connecting to each other, wherein the first coil is disposed at the inside of the second coil; a disposing step to dispose a part of a tail segment of the first coil on a last-loop segment of the second coil along a contour of the last-loop segment of the second coil; and a covering step to cover the first coil and the second coil.

To achieve the above objective, the present invention discloses a coil component, which comprises a first coil and a second coil. The first coil includes a tail segment. The second coil is disposed at the outside of the first coil and includes a last-loop segment. The tail segment is partially disposed on the last-loop segment along a contour of the last-loop segment.

As mentioned above, in the coil component and the manufacturing method thereof of the invention, the tail segment of the coil doesn't directly cross the outer coil to stretch outwards from the inside of the coil component. Instead, the tail segment is first adjusted onto the outer coil along the contour of the outer coil, and then stretched outwards from the outer coil. Therefore, the superimposed area of the tail segment of the inner coil and the outer coil is increased, so that the insulating layer of the coil is not easy to be cracked. Therefore, the invention can enhance the durability and life cycle of the coil component.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a top view of a conventional coil component;

FIG. 1B is a perspective view of the coil component as shown in FIG. 1A;

FIG. 2 is a flow chart of a manufacturing method of a coil component according to a preferred embodiment of the present invention;

FIGS. 3A to 3H are schematic diagrams of the manufacturing method of the coil component according to the preferred embodiment of the present invention;

FIGS. 4A and 4B are schematic diagrams of another aspect of the manufacturing method of the coil component according to the preferred embodiment of the present invention;

FIG. 5A is a top view of the coil component according to the invention;

FIG. 5B is a perspective view of the coil component as shown in FIG. 5A;

FIG. 6 is a perspective view of another aspect of the coil component of the invention;

FIG. 7A is a top view of another aspect of the coil component according to the invention; and

FIG. 7B is a perspective view of the coil component as shown in FIG. 7A.

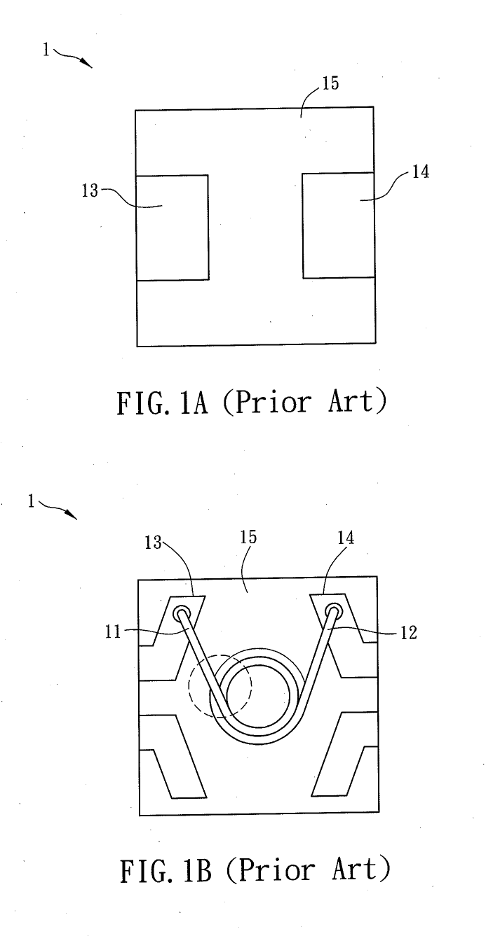

### DETAILED DESCRIPTION OF THE INVENTION

The present invention will be apparent from the following detailed description, which proceeds with reference to the accompanying drawings, wherein the same references relate to the same elements.

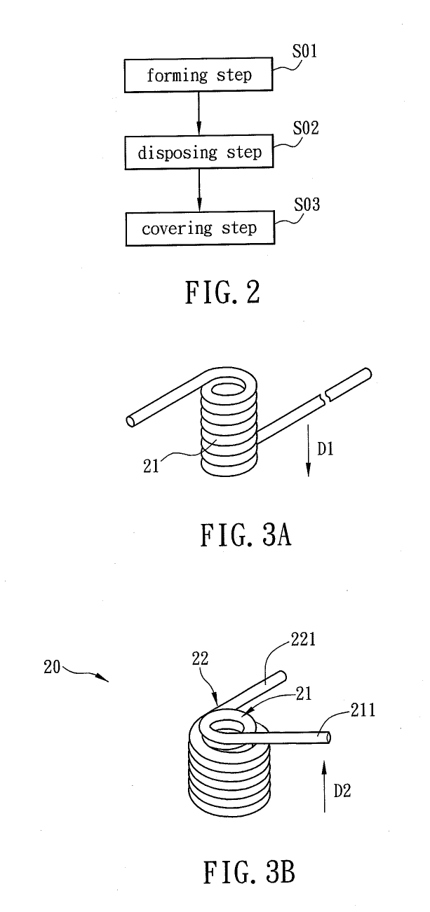

FIG. 2 is a flow chart of a manufacturing method of a coil component according to a preferred embodiment of the present invention.

As shown in FIG. 2, the manufacturing method includes the following steps.

The step S01 is a forming step to form a first coil and a second coil connecting to each other, wherein the first coil is disposed at the inside of the second coil.

The step S02 is a disposing step to dispose a tail segment of the first coil on a last-loop segment of the second coil according to the contour of the last-loop segment.

The step S03 is a covering step to cover the first coil and the second coil.

The first coil and the second coil are formed with the same wire, which includes a conducting wire as an inner layer and an insulating material covering the inner conducting wire. Hence, when two coils are disposed adjacent to each other and contact to each other, they will not have a short circuit. Herein, the coil can be but not limited to an enameled wire. The cross-section of the wire can be a circle for example, and can be otherwise, a quadrate or a flat shape.

Besides, between the step S02 and the step S03, the formed first coil and the second coil can be disposed and connected to a lead frame, and then in the step S03, the portion, on the lead frame, of the first coil and the second coil can be covered by a covering body. Afterwards, the main body of the lead frame is removed, and a conducting portion of the remaining part of the lead frame can serve as pins, which are connected to the first coil and the second coil in advance. The pins are bent along the surface of the covering body. The bent shape of the pins are determined according to the production requirement and design. The pins can serve as the electrode terminals for connecting the external circuit.

In the embodiment, the coil component can be used as a choke coil, which is also an inductor device and mainly used in filtering and inrush current limiting.

The following is the manufacturing method of the coil component for example.

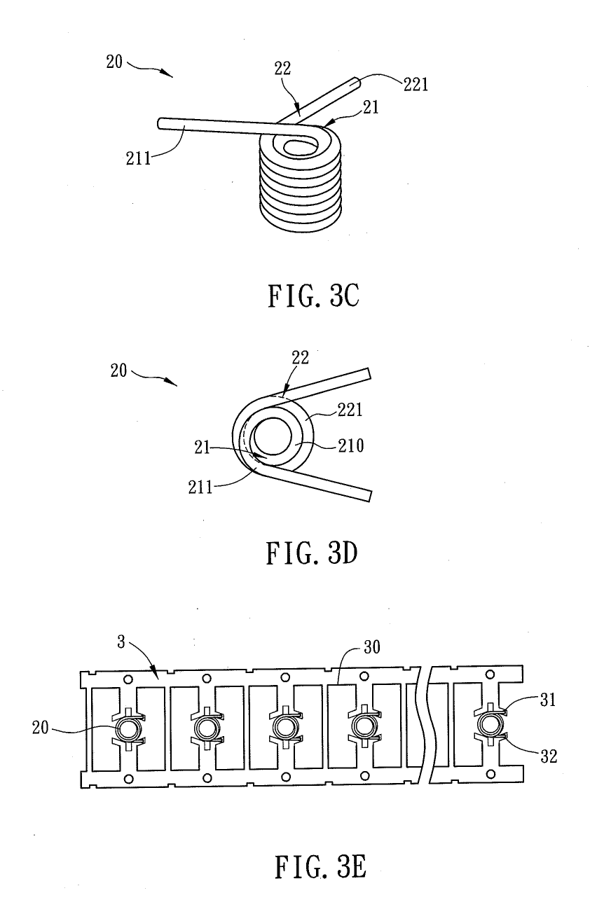

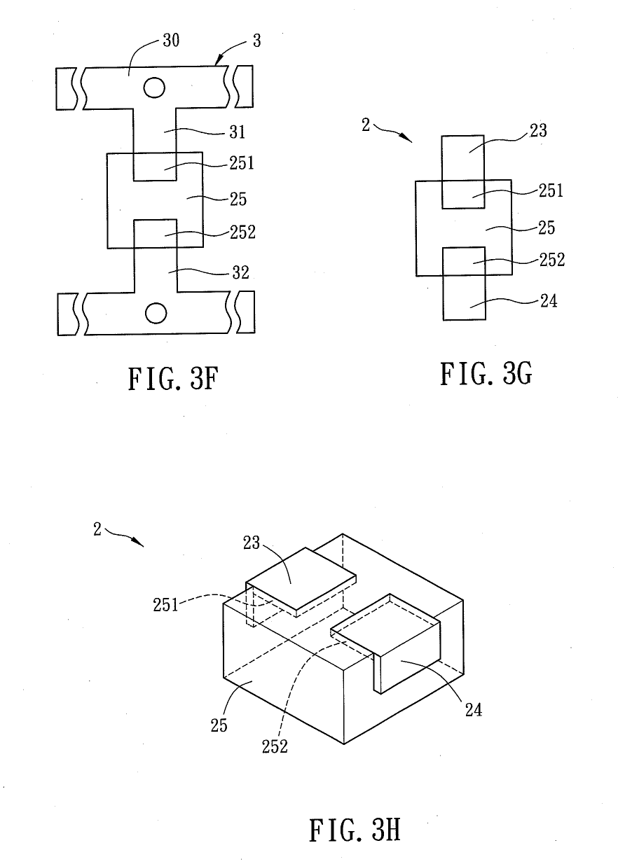

FIGS. 3A to 3H are schematic diagrams of a manufacturing method of a coil component according to a preferred embodiment of the invention.

As shown in FIGS. 3A and 3B, the coil component in the embodiment is wound to have two layers for example. As shown in FIG. 3A, a wire is wound clockwise and toward a first direction D1 (downwards for example) to form the first coil 21. Then, as shown in FIG. 3B, the remaining portion of the wire is wound clockwise, at the outside of the first coil 21, toward a second direction D2 (upwards for example) to form the second coil 22. Herein, the wire can be wound by a winding machine or a manual way.

Accordingly, the first coil 21 and the second coil 22 connected to each other becomes a winding coil 20. The first coil 21 is disposed at the inside of the second coil 22 and close to the inner edge of the second coil 22. The first coil 21 and the second coil 22 are wound vertically and spirally.

A tail segment 211 is the portion from the last loop of the first coil 21 to the tail end of the first coil 21. A last-loop segment 221 is the portion from the last loop of the second coil 22 to the tail end of the second coil 22. After the winding coil 20 (including the first coil 21 and the second coil 22) is formed, the tail segment 211 and the last-loop segment 221 are both disposed on one side of the winding coil 20, and the joint of the first coil 21 and the second coil 22 is located on the other side of the winding coil 20.

The inner coil can have more loops than the outer coil, and in the embodiment, the first coil 21 has more loops than the second coil 22 by at least one loop.

In the embodiment, the wire used to form the coil has a circle cross-section, for which the wire can be easily wound so as to assist the coil manufacturing. The wire can be an enameled wire.

Afterwards, as shown in FIG. 3C, the tail segment 211 is stretched from the first coil 21. In other words, the last loop of the first coil 21 is partially or totally stretched.

Then, as shown in FIG. 3D, the stretched tail segment 211 is partially disposed along the contour of the last-loop segment 221, so that the tail portion of the tail segment 211 is stretched outwards from the last-loop segment 221. For example, the tail portion of the tail segment 211 can be stretched outwards along a tangent of the contour of the last-loop segment 221. A main segment 210 of the first coil 21 is wound toward the first direction, and the tail segment 211 connecting to the main segment 210 is wound, from inside to outside, as a plane spiral. In other words, the main segment 210 and the tail segment 211 of the first coil 21 are wound as two types, in which the main segment 210 is wound as a three-dimensional spiral and the tail segment 211 is wound levelly over the outer coil. To be noted, because the coil component 2 is illustrated as two coil layers for example, the tail segment 211 may not have a complete loop.

As for the whole winding coil 20, the tail portions of the first coil 21 and the second coil 22 are respectively stretched outwards from the last loops of the winding coil 20.

In other embodiments, the first coil 21 and the second coil 22 can be wound counterclockwise. Besides, the first direction can be an upward direction, and the second direction can be a downward direction.

As shown in FIG. 3E, the winding coil 20 is then soldered to a lead frame 3.

In practice, plural winding coils 20 can be disposed on the lead frame 3. The lead frame 3 is used to fix the winding coils 20 for the following step forming the covering body of the coil component 2. Two portions 31 and 32 of the lead frame 3 can serve as the pins of the coil component 2.

As shown in FIG. 3F, the winding coil 20 (not shown) on the lead frame 3 is covered by a covering body 25, which can be formed by a mold. The main material of the covering body 25 can be, but not limited to, resin for insulating the winding coil from the outside environment. Besides, the covering body 25 can include magnetic material for enhancing permeability. For example, the covering body 25 is formed by mixing magnetic material and thermosetting resin, and a following curing process. Besides, the covering body 25 can have recesses 251 and 252 thereon.

As shown in FIG. 3G, after forming the covering body 25, the main portion 30 of the lead frame 3 is removed, and the remaining portions 31 and 32 can serve as two pins 23 and 24.

As shown in FIG. 3H, after being formed, the pins 23 and 24 are bent along the surface of the covering body 25. The pins 23 and 24 can be inserted into the recesses 251 and 252 of the covering body 25.

Otherwise, after the winding coil 20 is formed by the steps as shown in FIGS. 3A to 3D, it can be directly covered by the covering body instead of the steps as shown in FIGS. 3E to 3H. In this case, the two tail portions of the winding coil 20 directly serve as the electrode terminals for the external conduction. Besides, the covering step is only covering the main portion, such as the winding portion (coil core), of the first coil 21 and the second coil 22, so that the tail portions of the tail segment 211 and the last-loop segment 221 can be uncovered and exposed.

The manufacturing method of the winding coil 20 as shown in FIGS. 3A to 3D can have various aspects.

For example, during the process of winding, a segment of the tail portion of the wire can be expressly reserved to serve as the tail segment. In other words, the tail segment doesn't include the last loop of the first coil, so that the last loop of the first coil needn't to be stretched. Besides, similar as shown in FIG. 3D, once the most part of the tail segment is disposed along the contour of the last-loop segment, the tail portion of the tail segment will be naturally stretched outwards along a tangent of the last-loop segment. Subsequently, the winding coil whose tail segment has been adjusted can be continuously processed by the processes as shown in FIGS. 3E to 3H.

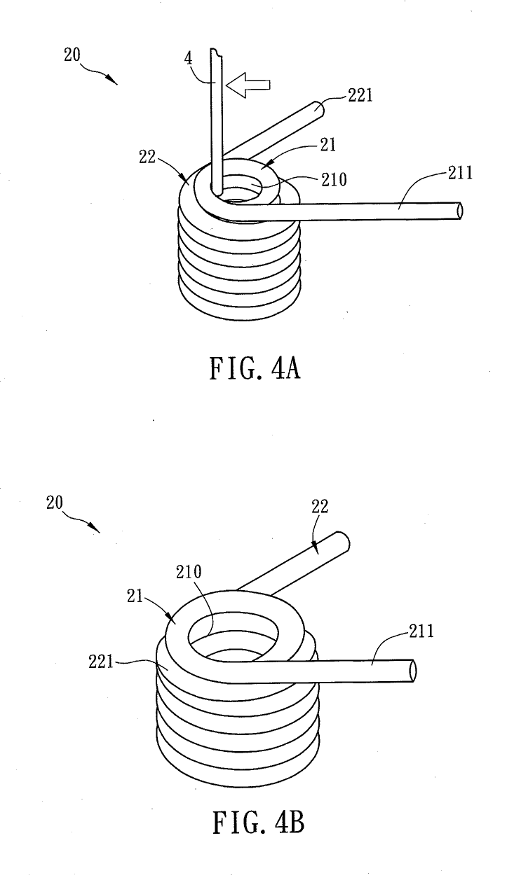

Another tail segment adjustment is as shown in FIGS. 4A and 4B. in the beginning, the winding coil 20 with its first coil 21 and the second coil 22 can be formed by the same steps as shown in FIGS. 3A and 3B. Then, as shown in FIGS. 4A and 4B, the tail segment 211 of the first coil 21 is moved onto the last-loop segment 221 of the second coil 22 by a push method, different from the steps as shown in FIGS. 3C and 3D. A push tool is disposed at the inside of the first coil 21 and outwards pushes the tail segment 211. In practice, as shown in FIG. 4A, the bottom of the push tool 4 is at the same level as the inside of the tail segment 211 with a beginning position on the inner contour of the main segment 210 of the first coil 21. Then, the push tool 4 is gradually moved outwards onto the main segment 210 while the winding coil 20 is rotated, so that the tail segment 211 is gradually pushed outwards. As shown in FIG. 4B, when the push tool 4 is moved onto the inner contour of the last-loop segment 221, the tail segment 211 is also pushed onto the last-loop segment 221, and the tail segment adjustment is completed. Afterwards, the winding coil 20 can be directly covered by the covering body instead of the steps as shown in FIGS. 3E and 3H. Besides, the two tail portions of the winding coil 20 can be used to serve as the electrode terminals for the external conduction. In this case, the covering step is only covering the main portion, such as the winding portion, of the first coil 21 and the second coil 22, so that the tail portions of the tail segment 211 and the last-loop segment 221 can be uncovered and exposed.

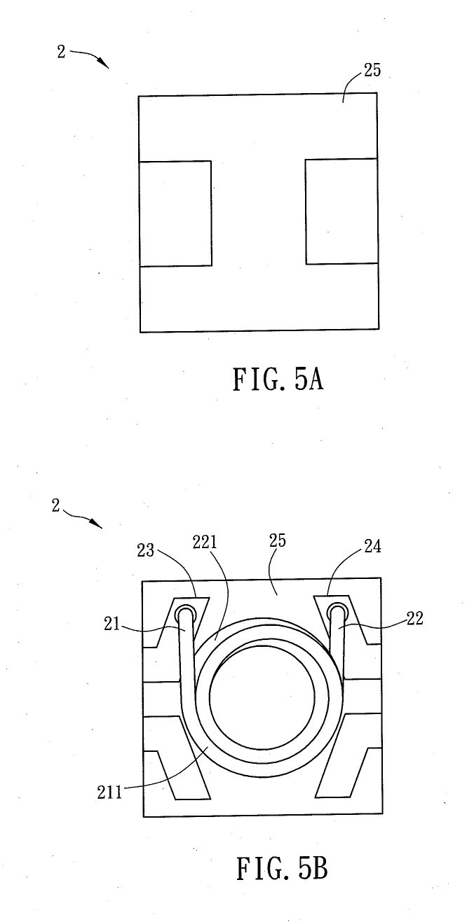

FIG. 5A is a top view of the coil component 2 according to the invention, and FIG. 5B is a perspective view of the coil component 2. As shown in FIGS. 5A and 5B, the coil component 2 includes the first coil 21, a second coil 22, a covering body 25, and two pins 23 and 24. The first coil 21 has the tail segment 211, and the second coil 22 is disposed at the outside of the first coil 21 and has the last-loop segment 221. The tail segment 211 is partially disposed on the last-loop segment 221 along the contour of the last-loop segment 221. The covering body 25 covers the first coil 21 and the second coil 22. The pins 23 and 24 are respectively connected to the tail segment 211 and the last-loop segment 221. The main segment of the first coil 21 is wound spirally according to the direction through the figure plane, and the tail segment 211 connecting to the main segment is wound from inside to outside to have a plane spiral.

The coil component 2 can be manufactured by the manufacturing method as mentioned in the above embodiments. The technical features of the first coil 21 and the second coil 22 have been illustrated as above, so the detailed descriptions are omitted here.

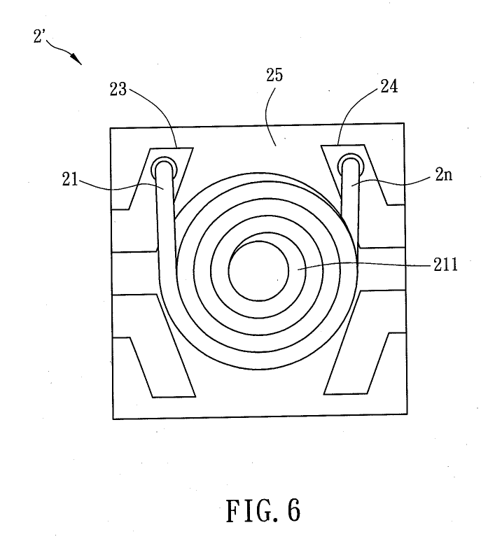

Different from FIG. 5B, the coil component 2′ as shown in FIG. 6 is not limited to a two-layer type, and can include more layers. For example, the coil component 2′ further includes a third coil which is disposed at the outside of the second coil, and the tail segment 211 is partially disposed along the contour of the last-loop segment of the second coil, and besides, the tail segment 211 is partially disposed along the contour of the last-loop segment of the third coil.

The tail segment of innermost coil 21 is not stretched radially, but is wound levelly on another layer coil. For example, the coil component 2′ includes, from inside to outside, a first coil 21, a second coil 22, . . . , and an nth coil 2n, and each of them is connected with the adjacent one. The first coil 21 and the nth coil 2n respectively have tail portions that are not connected with other coils, and the tail segments of the first coil 21 and the nth coil 2n are disposed on one side of the coil component 2′. Besides, the tail segment of the first coil 21 is wound levelly, from inside to outside, onto the last loops of the second coil, . . . , and the nth coil 2n. FIG. 6 is a schematic diagram showing an example as n equals to 4. In summary, the main segment and the tail segment 211 of the first coil 21 are wound as different types, in which the main segment 210 is wound as a three-dimensional spiral and the tail segment 211 is wound levelly over the outer coil.

The inner coil can have more loops than the outer coil. In the embodiment, the first coil 21 has more loops than other coils (such as the second coil 22 to nth coil 2n) by at least one loop. Other coils can have the same number of loops.

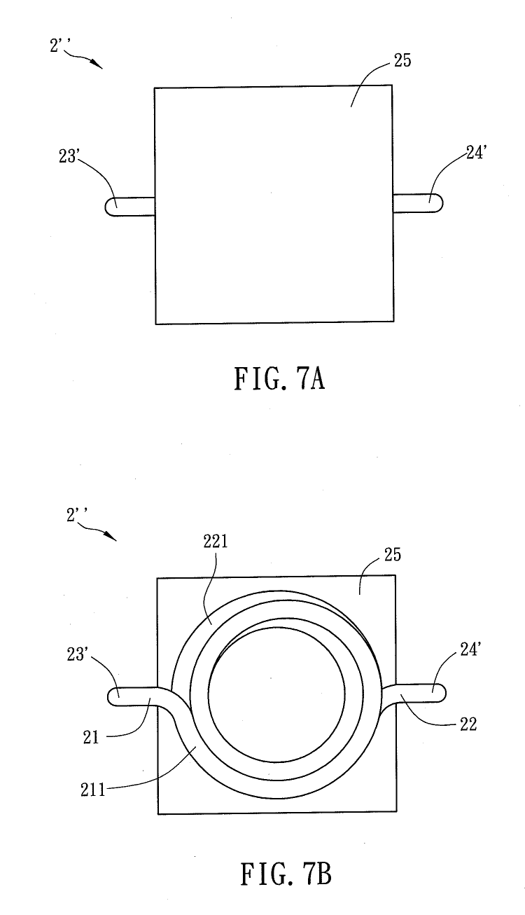

FIG. 7A is a top view of a coil component 2″ of the invention, and FIG. 7B is a perspective view of the coil component 2″. As shown in FIGS. 7A and 7B, the tail portions of the coils can serve as the electrode terminals 23′ and 24′.

The winding coil can be made either by the manufacturing method as shown in FIGS. 3A to 3D or by the manufacturing method as shown in FIGS. 4A and 4B. The winding coil as shown in FIG. 3D or in FIG. 4B is directly covered by the covering body 25. In other words, the tail segment 211 of the first coil 21 and the last-loop segment 221 of the second coil 22 are not soldered to the lead frame. The covering body 25 only covers the main portions, such as the winding portions, of the first coil 21 and the second coil 22, and the tail portions of the tail segment 211 and the last-loop segment 221 are uncovered and exposed from the covering body 25 to serve as the electrode terminals 23′ and 24′. In the embodiment, the diameter of the winding coil of FIGS. 7A and 7B is larger than that of the winding coils of FIGS. 3A to 6, and the winding coil can include a copper wire and an insulating layer covering the copper wire.

Besides, the coil component 2″ can include a plurality of coil layers. For example, the coil component 2″ further includes a third coil, which is disposed at the outside of the second coil 22, and the tail segment 211 is partially disposed along the contour of the last-loop segment of the second coil and also partially disposed along the contour of the last-loop segment of the third coil. The related details are similar to the illustration in FIG. 6, so the detailed descriptions are omitted here.

Similar to the coil components as shown in FIGS. 5A to 6, the main segment of the first coil 21 is wound toward the first direction, and the tail segment 211 connecting to the main segment is wound, from inside to outside, as a plane spiral.

In other words, the main segment and the tail segment of the first coil 21 are wound as different types, in which the main segment 210 is wound as a three-dimensional spiral and the tail segment 211 is wound levelly over the outer coil. Besides, because the coil component 2″ is illustrated as two coil layers for example, the tail segment 211 may not have one complete loop. The first coil 21 and the second coil 22 are wound vertically and spirally, and the tail segment 211 of the first coil 21 is partially superimposed on the last-loop segment 221 of the second coil 22. The related details are similar to the illustration in FIGS. 5A to 6, so the detailed descriptions are omitted here.

In the all above embodiments, no matter how many coils the coil component has, the two tail potions of the winding coil are respectively stretched from the last loops of the winding coil. Besides, the first coil and the second coil are mainly wound as a vertical spiral, but the tail segment of the first coil is adjusted to be levelly superimposed on the last-loop segment of the second coil. When the coil component is manufactured, the first coil at the inner side can be first formed, then the second coil at the outer side is formed, and then the tail segment of the first coil is adjusted to be partially disposed on the last-loop segment of the second coil. In other words, the coil component includes plural coils disposed from inside to outside sequentially. The inmost coil has a tail segment, each of the other coils has a last-loop segment, and the tail segment is partially disposed on the last-loop segments along the contours of the last-loop segments.

The tail segments of the first coil and the second coil are both disposed on one side of the coil component, and the tail portions of the tail segments serve as the pins for the external conduction. For example, the tail portions of the tail segments can directly serve as the electrode terminals to electrically connect to the external circuit, or electrically connect to the external circuit through the pins.

In summary, in the coil component and the manufacturing method thereof of the invention, the tail segment of the coil doesn't directly cross the outer coil to stretch outwards from the inside of the coil component. Instead, the tail segment is first adjusted onto the outer coil along the contour of the outer coil, and then stretched outwards from the outer coil. Therefore, the superimposed area of the tail segment of the inner coil and the outer coil is increased, so that the insulating layer of the coil is not easy to be cracked. Therefore, the invention can enhance the durability and life cycle of the coil component.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A manufacturing method of a coil component, comprising:
a forming step to form a first coil and a second coil connecting to each other, wherein the first coil is disposed at the inside of the second coil;
a disposing step to dispose a part of a tail segment of the first coil on a last-loop segment of the second coil along a contour of the last-loop segment of the second coil; and
a covering step to cover the first coil and the second coil.

2. The manufacturing method of a coil component as recited in claim 1, further comprising:
a soldering step to solder the first coil and the second coil to a lead frame;
a removing step to remove the lead frame to form two pins after the covering step; and
a bending step to bend the pins.

3. The manufacturing method of a coil component as recited in claim 1, wherein the forming step further comprises:
spirally winding a first portion of a wire toward a first direction to form the first coil; and
spirally winding a second portion of the wire toward a second direction to form the second coil outside the first coil, wherein the first direction is opposite to the second direction.

4. The manufacturing method of a coil component as recited in claim 1, wherein the disposing step further comprises:
stretching the tail segment from the first coil; and
disposing the tail segment along the contour of the last-loop segment.

5. The manufacturing method of a coil component as recited in claim 1, wherein the disposing step further comprises:
pushing the first coil from the opposite side of the tail segment so that the tail segment is protruded; and
adjusting the tail segment onto the last-loop segment.

6. The manufacturing method of a coil component as recited in claim 1, wherein the covering step is only to cover main portions of the first coil and the second coil, so that the tail portions of the tail segment and the last-loop segment are uncovered and exposed.

7. The manufacturing method of a coil component as recited in claim 1, wherein a mina segment of the first coil is wound spirally toward a first direction, and the tail segment connecting to the main segment is wound from inside to outside, spirally and levelly.

8. A coil component, comprising:
a first coil including a tail segment; and
a second coil disposed at the outside of the first coil and including a last-loop segment, wherein the tail segment is partially disposed on the last-loop segment along a contour of the last-loop segment.

9. The coil component as recited in claim 8, wherein a main segment of the first coil is wound spirally toward a first direction, and the tail segment connecting to the main segment is wound from inside to outside, spirally and levelly.

10. The coil component as recited in claim 8, further comprising:
a covering body covering the first coil and the second coil; and
two pins respectively connected to the tail segment and the last-loop segment.

11. The coil component as recited in claim 8, further comprising:
a third coil disposed at the outside of the second coil, wherein the tail segment is partially disposed along a contour of a last-loop segment of the third coil.

12. The coil component as recited in claim 8, wherein the first coil and the second coil are wound vertically and spirally, and a part of the tail segment of the first coil is disposed levelly on the last-loop segment of the second coil.

13. The coil component as recited in claim 8, wherein the coil component is a choke coil.

14. The coil component as recited in claim 8, wherein the covering body only covers main portions of the first coil and the second coil, so that the tail portions of the tail segment and the last-loop segment are uncovered and exposed.
